(19) United States
(12) Patent Application Publication
(10) Pub. No.: US 2005/0058897 A1
(43) Pub. Date: Mar. 17, 2005

(54) Reinforced components for electrochemical cells

(76) Inventor: Craig Andrews, College Station, TX (US)

Correspondence Address: STREETS & STEELE, 13831 NORTHWEST FREEWAY, SUITE 355, HOUSTON, TX, 77040, US

(21) Appl. No.: 10/727,820

(22) Filed: Dec. 4, 2003

Related U.S. Application Data
(60) Provisional application No. 60/431,009, filed on Dec. 4, 2002.

(51) Int. Cl. H01M 2/00; H01M 8/02; H01M 8/24

(52) U.S. Cl. 429/163; 429/37

(57) ABSTRACT

Polymeric electrochemical cell components having a perimeter edge reinforced by a band or hoop that is preferably made from a high tensile strength material that resists elongation under tension. Preferred band materials include metals and polymer fibers such as aromatic polyamide fibers. The band may be positioned around the perimeter of the polymer component in any reasonable fashion, including pressed fit around the component, formed about the component, wound about the component, or merely positioned adjacent at a narrow gap from the component. Furthermore, the band may be dedicated to a single component or the band may reinforce the plurality of component that establish a sub-assembly, sub-stack or complete stack of electrochemical cells.

This application claims priority to U.S. Provisional Patent Application No. 60/431,009 filed on Dec. 4, 2002.

### BACKGROUND OF THE INVENTION

1. Field of the Invention

The present invention relates to electrochemical cell components for use in high-pressure applications. More particularly the invention relates to a lightweight cell frame for use with a high-pressure electrochemical cell.

2. Background of the Related Art

Electrochemical cells include electrolysis cells, fuel cells, oxygen pumps, and batteries. Some electrochemical cells have applications that require high-pressure reactants, products, or cooling fluids. For example, a regenerative fuel cell that uses oxygen gas as the oxidant during its electric power generation cycle will typically be operated at high pressure to reduce the storage volume of the oxygen gas and to increase the electrical output from the fuel cell. Operating in the regenerative cycle, the regenerative fuel cell operates as an electrolyzer to produce pressurized hydrogen and oxygen from water with essentially no energy penalty for producing these gases at high pressure. These produced gases are then fed back to the regenerative fuel cell during the electric power generation cycle. Accordingly, the regenerative fuel cell can be operated at high pressure to achieve greater electrical voltages without suffering high efficiency losses as would occur if power was required to run gas compressors. However, to take advantage of these pressurized gases it is necessary to design the physical structure of the fuel cell or other electrochemical cell to handle the internal pressures of these gases or liquids.

Electrochemical cells include various types, such as alkaline, phosphoric acid, solid oxide, and proton exchange membrane cells. Each of these types are named for the type of electrolyte used in the electrochemical cell. The proton exchange membrane (PEM) cell is of great interest due to its low temperature operation and its potential for lightweight design of electrochemical cell stacks. When operating PEM cells at high pressure it is necessary to provide seals between adjacent components. Efforts to reduce the weight of these plainer components has lead away from the use of heavy metal plates or thick graphite members and toward the use of thin polymer components or composite components. However, these polymer components have inherent temperature and strength limitations that the design must take into account.

In order to seal PEM cells, a gasket is typically employed between two adjacent members. Sealing is achieved by forcing the adjacent members together and thereby compressing the gasket. Alternatively, adhesive bonding may be used to seal adjacent components, thereby eliminating the need for high compressive forces to achieve the seal. However, both of these sealing techniques rely upon the continued physical integrity of the adjacent components. For example, establishing a seal between a gas barrier plate and a membrane and electrode frame requires that these two components remain plainer. If, during operation, either of these two components is allowed to creep, warp, crack, or otherwise deform, than the gasket may no longer be effective. Furthermore, any deformation of the components may affect fluid flows through the cell or cause leakage or co-mingling of fluids within the cell. Further still the deformation may cause a loss of a reactant or product gas or liquid to the surrounding atmosphere. It is apparent that the loss of integrity of an electrochemical cell component should be avoided.

Ongoing efforts in electrochemical cell design are not only directed to reducing the weight of the cell, but are also directed toward reducing the size of the cell. Therefore the geometries of the components are reduced to their inherent limits.

Accordingly there is a need for lightweight, high strength electrochemical cell components. More particularly it would be desirable to have an electrochemical cell component, such as a cell frame, that was made of a material selected for chemical compatibility within the cell, was designed in a geometry suitable for the fluid flow rates and pressure drops required of the cell, yet of sufficient strength to resist deformation and loss of containment of the pressurized fluids. It would be further desirable if the strength of these lightweight components could be increased without adding significantly to the weight or bulk of the cell.

### SUMMARY OF THE INVENTION

The present invention provides an apparatus for use in electrochemical cells and cell stacks. The apparatus comprises a generally planar component that may be used in a high-pressure electrochemical cell and a band that encircles the perimeter edge of the component. The band has an elasticity that minimizes the deformation of the component by pressurized fluids contained within the electrochemical cell or cell stack.

The component may be press-fit into the band or the band may be formed around the component. The band may be made from a metal or a polymer. Preferably the band comprises polyamide fibers. The polyamide fibers may be bound together with a polymer, preferably with the same polymer as used to make the component if the component is made of a polymer.

The pressurized fluids contained within the electrochemical cell or cell stack press against the component and the component presses outward against the band. The force imparted by the pressurized fluids put the band in tension.

In an electrochemical cell or cell stack having a plurality of components, a plurality of bands may encircle the components, each band encircling one of the plurality of components. Likewise, a plurality of electrochemical cells or sub-stacks may be encircled with a plurality of bands, each band encircling one of the plurality of electrochemical cells or sub-stacks.

The present invention also provides an electrochemical cell comprising a stack of generally planar components each having a perimeter edge, wherein the components include at least one polymer frame for containing reactant fluids, and a band extending around the perimeter of the stack of components to reinforce the polymer frame against deforming under the pressure of the reactant fluids. The stack of components may include an electrically conductive bipolar plate. Furthermore, the bipolar plate may have a perimeter edge that is radially inward from the perimeter edge of the polymer frames. In this manner, the bipolar plate will not short circuit the electrochemical cell stack when the band is also electrically conductive.

To position the band around the perimeter of the stack, the band may be wound around the perimeter edge of the stack of components.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a perspective view of a polymer frame for use in an electrochemical cell.

FIG. 2 is a cross sectional side view of the polymer frame of FIG. 1.

FIG. 3 is a cross sectional side view of an electrochemical cell stack disposed within a reinforcing band during assembly.

### DETAILED DESCRIPTION OF THE INVENTION

The present invention provides polymeric electrochemical cell components having a perimeter edge reinforced by a band or hoop. The band or hoop is preferably made from a material having a high tensile strength that resists elongation under tension. Preferred materials for forming the band include metals and polymer fibers such as aromatic polyamide fibers, available under the trademark PEVLAR, a registered trademark of Dupont, a corporation of Wilmington, Del. Furthermore, the band may be positioned around the perimeter of the polymer component in any reasonable fashion. For example, the band may be pressed fit around the component, formed about the component, wound about the component, or merely positioned adjacent at a narrow gap from the component. Furthermore, the band may be dedicated to a single component or the band may reinforce the plurality of component that establish a sub-assembly, sub-stack or complete stack of electrochemical cells.

While the banding member is preferably not electrically conductive, the band may be electrically conductive so long as the band causes no short-circuiting of the cell. Therefore it is preferable, when using an electrically conductive band, to reduce the diameter of any electrically conducting cell component so that the electrically conducting cell components do not extend to the same perimeter portion of the cell stack where electrical contact can be made with the band. Conversely, where an electrically non-conducting band is used, no such considerations are necessary and the diameters of the electrically conducting cell components do not have to be so limited.

Because of the high tensile strength of some materials relative to the pressures encountered in the electrochemical cell, it may be possible for the band to occupy only a narrow region around the perimeter of the component or stack of components. Accordingly the band can be added to the dimension of the component or stack without significantly increasing the overall size of the device. Alternatively, the band may be incorporated within the existing dimensions and specifications of the component or stack without interfering with the operation of the component. For example, in one embodiment a circular polymer frame in the shape of a ring may be made having a thickness of approximately one millimeter, an outer diameter of 20 centimeters, an inner opening of approximately 16 centimeters, and weighing less than one ounce. Encircling the frame with a one millimeter wide polyamide fiber-reinforcing band requires only one millimeter of the two-centimeter width of the cross section of the frame.

While the overall shape of the electrochemical cell component is not to be limited, it is highly preferred that the high pressure components be formed in the shape of a circle so that the internal forces applied against the band by the pressurized fluids will be evenly distributed about the band. In addition, the circular shape allows the band to oppose the inside pressure forces using only its high tensile strength. Reinforcement of a rectangular component essentially requires that the banding element resist bending.

It is also highly preferred that the band be integrated with the polymer component to avoid increasing the part count and to avoid the difficulties of positioning the band around a separate component. Snap fitting, friction fitting, adhesive bonding, thermal welding and other known fastening techniques may be used to integrate the band with the polymer component. These same techniques may be used whether the banding element is dedicated to an individual component or whether the band is reinforcing a plurality of components. For example, a stack or sub-stack of components may be fully assembled before a reinforcing band is applied to the outer perimeter of the sub-stack. Accordingly, the band may be snapped in place, clamped, adhesively bonded, wrapped or otherwise fastened to the perimeter of the sub-stack.

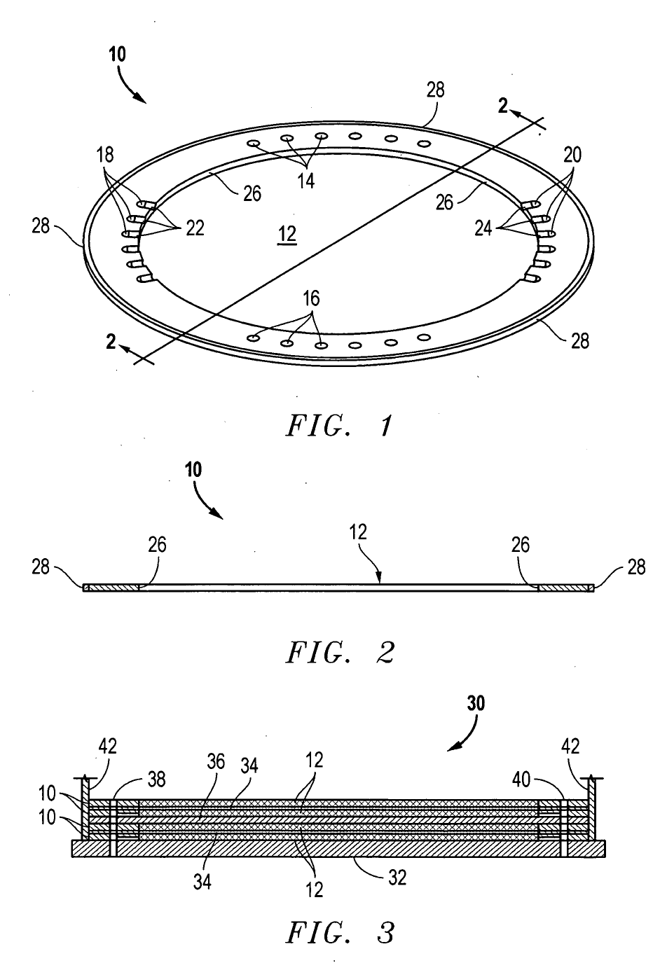

FIG. 1 is a perspective view of a polymer cell frame suitable for use in a high-pressure electrochemical cell. The frame 10 has open area in the center of the frame 10 for receiving a flow field 12 or other component of an electrochemical cell (not shown). The frame 10 includes one set of manifold holes 14, 16 that may, for example, conduct a fluid to and from an anode flow field, as well as another set of manifold holes 18, 20 with flow channels 22, 24 that may, for example, provide fluid communication across a cathode flow field. If a fluid is provided at high pressure to the flow field 12 contained in the center of the frame 10, a force is exerted in all directions against the inside brim 26 of the frame. The manifolds and flow channels 18, 20, 22, 24 also have forces exerted against them by the high-pressure fluid, so consequently there is a net outward force on the frame 10 that must be opposed to contain the fluid. The frame 10 is shown with a reinforcing band 28 formed integrally around the perimeter of the frame 10. The preferred band 28 comprises aromatic polyamide fibers mixed with a polymer binder that may be the same polymer as the remainder of the frame 10. Using the same kind of polymer to form the frame and to bind the polyamide fibers helps avoid delamination of the fibers as well as avoid different dimension changes of the band and of the frame during thermal cycling due to different materials having different expansion coefficients. The band 28 is also shown in its preferred arrangement extending from a top surface of the frame to the bottom of the frame. The polymeric frame may be made of polymers selected from If the plate is made of a polymer, preferred polymers include polyvinylidene fluoride, polyvinylidene difluoride, polytetrafluoroethylene, polyamides, polysulfone, polyetherketones, polycarbonate, polypropylene, polyimides, polyurethanes, epoxies, silicones, and combinations thereof. The plate may be formed, for example, by injection molding or by being machined from a solid block of the polymer.

FIG. 2 is a cross-sectional side view of the polymer cell frame 10 shown in FIG. 1. The preferred arrangement as shown with the band 28 running from the top surface of frame 10 to the bottom surface of frame 10 to fully oppose the forces along the inner surface 26.

FIG. 3 is a cross-sectional side view of a bipolar stack of electrochemical cells during assembly. From bottom to top the stack 30 is shown to include an end plate 32 and a first flow field 12 in planar communication with a first frame 10. A membrane and electrode assembly 34 is placed over the first flow field 12. A second flow field 12 in a frame 10 is provided in communication with the second side of the MEA 34. A bi-polar gas separator 36 is than provided on top the second flow field 12. Above the bi-polar plate 36, the unit cell is repeated including a flow field 12 and frame 10 combination, a membrane and electrode assembly 34 and another flow field 12 and frame 10 combination. This type of cell construction can be repeated with bi-polar gas separators between adjacent cells. For sake of completeness, it should be recognized that the frames 10 provide manifolds 38,40 for the fluid communications required by the flow fields 12 adjacent to the electrodes of the MEAs 34.

A banding member 42 is shown disposed around the perimeter of the plurality of components establishing the stack 30. While the band 42 may surround a number of components, the band 42 is shown encompassing two or more complete electrochemical cells. As shown, the bipolar gas barrier plates 36 extend to a diameter that makes contact with the band 42. Accordingly, if the gas barrier plate 36 is electrically conducting, which is the typical case, then the band 42 should be electrically non-conducting to avoid providing an electrical short circuit between the cells.

It should be recognized that the general configuration of the band relative to the electrochemical cell components shown in FIG. 3 would be the same regardless of whether the components are frictionally engaged within a rigid band 42 or whether the band 42 is formed around the stack of cells. Even though the band 42 generally resists deformation of the frames 10 and improves the sealing between components, it is generally still necessary to provide some means of compressing the components in the stack.

It will be understood from the foregoing description that various modifications and changes may be made in the preferred embodiment of the present invention without departing from its true spirit. It is intended that this description is for purposes of illustration only and should not be construed in a limiting sense. Only the language of the following claims should limit the scope of this invention.

1. An apparatus, comprising:
a generally planar component for use in a high pressure electrochemical cell; and
a band encircling a perimeter edge of the component, wherein the band has an inelasticity that minimizes deformation of the component by pressurized fluids.

2. The apparatus of claim 1, wherein the component is press-fit into the band.

3. The apparatus of claim 1, wherein the band is made from a metal or a polymer.

4. The apparatus of claim 1, wherein the band is formed around the component.

5. The apparatus of claim 1, wherein the generally planar component is a polymer component.

6. The apparatus of claim 5, wherein the pressurized fluids press against the component and the component presses outward against the band.

7. The apparatus of claim 5, wherein the pressurized fluids impart a force against the band that puts the band in tension.

8. The apparatus of claim 1, further comprising:
a plurality of generally planar components and a plurality of bands, each band encircling one of the plurality of components.

9. The apparatus of claim 1, further comprising:
a plurality of electrochemical cells and a plurality of bands, each band encircling one of the plurality of electrochemical cells.

10. The apparatus of claim 1, further comprising:
a plurality of sub-stacks and a plurality of bands, each band encircling one of the plurality of sub-stacks.

11. The apparatus of claim 1, wherein the bands comprise aromatic polyamide fibers.

12. An electrochemical cell, comprising:
a stack of generally planar components each having a perimeter edge, wherein the components include at least one polymer frame for containing reactant fluids; and
a band extending around the perimeter of the stack of components to reinforce the polymer frame against deforming under the pressure of the reactant fluids.

13. The cell of claim 12, wherein the stack of components includes an electronically conductive bipolar plate.

14. The cell of claim 13, wherein the bipolar plate has a perimeter edge that is radially inward from the perimeter edge of the polymer frames.

15. The cell of claim 14, wherein the band is electrically conductive.

16. The cell of claim 12, wherein the band is wound around the perimeter edge of the stack of components.

17. The cell of claim 12, wherein the band is positioned around the perimeter-of the stack.
